(19) United States
(12) Patent Application Publication
(10) Pub. No.: US 2013/0144668 A1
(43) Pub. Date: Jun. 6, 2013

(54) INTERNET BASED DYNAMIC FLIGHT RESERVATION SYSTEM AND ITS METHOD OF USE

(71) Applicants: Manish PURI, Mississauga (CA); Sergej SOKOLOV, Mississauga (CA); Dmitry SERGIEIEV, Vinnitsa (UA)

(72) Inventors: Manish PURI, Mississauga (CA); Sergej SOKOLOV, Mississauga (CA); Dmitry SERGIEIEV, Vinnitsa (UA)

(21) Appl. No.: 13/312,554

(22) Filed: Dec. 6, 2011

(51) Int. Cl. G06Q 10/02

(52) U.S. Cl. 705/6

(57) ABSTRACT

A global flight center (GFC) having an improved global reservation system for passenger and cargo aircrafts and allows for the consolidation of aircraft flight schedules worldwide. It operates over the Internet by giving system users the ability to reserve aircraft in real time globally. With the creation of a new (hardware and software) system, the system creates an improved marketing method and possibilities between broker agencies and aircraft owner operators. For users of this new system, the new method creates an exclusive reservation system and relationship between all agents and broker parties—to the aircraft operators. This is accomplished by means of the GFC system's resources managing recruiting or registration style process which is done through the GFC interactive application on the website.

### FIELD OF THE INVENTION

The present invention relates generally to the field of aviation and aviation logistics, in particular to people/cargo transportation and reservation systems related with aviation logistics. More particularly the invention relates to a reservation systems conducted over a registered network of aircraft operators over the worldwide (global) internet using hardware and software resources and operating on the real-time (online) conditions.

### BACKGROUND OF THE INVENTION

Methods used for reserving aircraft, whether private or commercial are traditionally very proprietary in nature. Airline companies all compete to market their aircraft individually or through travel agencies and brokers to sell vacancies to various destinations using advertising incentives, online discounts and a variety of other marketing schemes/systems consisted of many tools and its hardware/software implementations.

The following, to analyze in more details the current technical level, there are indicated patents and patent applications wherein there are described schemes, models and systems/tools that can be investigated comparing them with the present invention.

KR20070061284 patent (published on Jun. 13, 2007). This patent is designed as an apparatus for managing inventory in the internet-based multi-stage logistics collaborative system. It represents an invention with the scope and realization to provide more efficiency in inventory management methods in its invention. The goal of this invention is only to increase profitability by the introduction of a new systematic methodologies.

WO2009032931 patent application (published on Mar. 12, 2009). This patent application related to real-time communication validation system, which represents an invention with the scope and realization to provide more efficiency in communication systems with affiliate systems within an infrastructure in its invention only. The goal of this invention to simply increase profitability and information reliability by the invention of new systematic methodologies.

US2004260581 patent (published on Dec. 23, 2004). This patent is designed to facilitate profitability using centralized information networks in which data is collected for the benefit of travel service suppliers and buyers. It appears to be in essence a facilitation system as described. It only represents an invention with the scope and realization to provide more efficiency in communication systems with affiliate systems within an infrastructure in its invention.

WO02069078 patent application (published on Sep. 6, 2002). This patent application represents a facilitation system oriented to get more efficiency and convenience in event ticketing systems with affiliate systems within an infrastructure in its invention set to increase profitability and customer convenience by the invention of new systematic methodologies in this invention.

US2008010105 patent (published on Jan. 10, 2008). This is designed to provide convenience and efficiency for merchants using software apparatus, using the internet and centralized data bases to create a reservation system. This patent, like many others have tried to provide convenient means to get information once data is centralized and prepared for delivery. The patent uses software embedded on computers to connect to the internet. As described in the patent, these methods enable the capture of user profiles and demographic data to yield a true purpose of creating a “highly targeted and effective marketing and promotional ad campaign”. It clearly represents an invention with the scope and realization to provide more efficiency and convenience in event reservations.

US2009171782 patent (published on Jul. 2, 2009). This patent is designed to provide convenience and efficiency for users with a primary goal to earn advertising commissions as described. As described in the patent, these methods process flight data and “provide at least one of the plurality of advertisements to the user over the telephone network while the flight information is being determined”. US2004060593 patent (published on Feb. 12, 2004). This patent is designed to patent a consolidation concept, which uses centralized information networks in which data is collected for the benefit of system users travel service suppliers and end customers. This basic concept represents an invention with the scope and realization to provide more efficiency in communication systems with affiliate users.

Within the current (traditional) system and the patents shortly described above, these agencies and brokerages are able to reserve flights for their customers based on the availability of the aircraft. The availability of an aircraft is gained by the flight schedules which are provided by the aircraft operators. With flight schedules known, the entire reservation logistics process begins. Generally, an agent or broker would not be able to reserve an aircraft or book a seat for which they had no flight schedule. They would have to revert to finding other operator schedules available to them to complete their bookings. This process is limited by the number of airline operators available to these agencies and also their respective relationships with them. Furthermore, the means in which these reservations are done can be a tedious task if the logistical data of the flight and schedules are unknown. Generally, the labor intense task of researching unknown flights and their schedules are done manually. For example, calling on contacts and other operators available, researching the Internet for flight availability, schedules, prices and so on.

To meet the challenges of reservation logistics, there are consolidator agencies that have integrated flight schedules of airline operators. There are websites created to allow Brokers and fellow agencies to login and reserve aircraft using their systems but again, they too are limited to their respective relationships with operators and also by the inability of visualizing flight schedules of other aircraft available to them. To solve the above mentioned limitations, comes the creation of the special Global Flight Center (GFC) Internet Based—Dynamic Flight Reservation System. The creation and invention of the GFC interactive website and software/hardware system has automated this process. The system and its ability to globally consolidate connected aircraft flight schedules form the foundation in which embodiments of the invention are found. It enables users (customers, travel agents/brokers and operators) to visualize in real time, flight schedules and availabilities of all aircraft (commercial or chartered) that are registered on the GFC Network. With the creation of the GFC flight reservation system, and by the consolidation of connected operator flight schedules through the GFC Network—travel agents, brokers and reservationists have not only found a new resource, but also a new opportunity for generating new income streams. The data gathered in the system from registrants in the GFC Network allow for the creation of the new marketing methods and strategies which demonstrate the unique embodiments of the invention. The GFC system and its use highlights an exclusive relationship model between brokers and aircraft operators and a special broker to broker commission model both creating an improvement in current methods in which all parties can increase their reservations commissions. This concept and method does not exist in the aviation industry today.

So where a broker or agent who may have only the resources of 10 operators and their respective flight schedules to sell from would now have literally all aircraft operator schedules available to them so long as the Operators were registered on the GFC Networks website. Furthermore, once an aircraft is registered on the GFC Network by a particular Broker, all Brokers have access to the inventory and benefit from a commission sharing structure created within the system.

Currently, a number of companies have attempted to organize, consolidate and streamline the reservation systems for aircraft over the Internet in real time. This again is fundamental to the invention. However, to date, these attempts have been unsuccessful. None of the Internet based sites and systems have been able to truly consolidate connected flight schedules of aircraft and done so in a virtual real time environment. The marketing methods used within their systems do not cultivate a real time automated capability for brokers to share commissions with one another which is one fundamental realization and creation of the invention. Often times, many broker websites present themselves as having an abundance of aircraft available to choose from, boasting variety and availability—but none of them really have connected flight schedules to visualize availability in real time. Enquiries online through their websites are often met with a call-back type response which then generally lead to additional reservation questions of other aircraft availability and price should that response be unsuitable or unavailable to the customer. This back and forth session exposes inefficiencies in their system and is time consuming for all parties involved. Furthermore, not having a connected flight schedule seriously limits the brokers earning potential as they can only book what's in inventory and/or struggle to reach out to other relationships with operators to meet the customers' demands. The Brokers are always limited to the operators they can find or know through available resources. This again costs a lot of time and exposing big inefficiencies in their system capability, marketing models and the methods they use to carry out their business. This is the current landscape for reservation logistics today. Some examples of Internet based broker/operator and consolidator sites that demonstrate these limited reservations logistics methods are: www.airbrokernet.com; www.aviation-broker.com; www, huntingtontravel.net; www.netjets.com; www.avinode.com.

Air Broker Net.com is one Internet based brokerage company. The site demonstrates affiliations with various airline operators. They express traditional marketing methods to sell their services, compete with other brokers and earn reservation commissions. Here however, the reservations of aircraft are limited to the number of airline operators in their inventory and resource capability. Also, a competitor broker wishing to partner to reserve aircraft here are met with laborious tasks involving scheduling, price, aircraft size and other vital details including referral fee negotiations more than likely if at all available. While competitor brokers may choose to engage in a possible sharing relationship—this process is not automated in real time and furthermore is limited to the resources and inventory available from the partnering broker. With the Air Net Broker.com approach, there is no demonstration of any automation of commission sharing between brokers in real time and clearly have a limited resource base of aircraft in inventory to choose from not only for themselves but also for other possible broker cooperative endeavors.

Aviation-Brokers.com is another Internet based broker/operator site that also demonstrates prior limited reservations logistics methods and systems. Like Air Broker Net.com, Aviaton-Broker.com affiliates with various aircraft operators. They too use traditional marketing methods to compete in the aviation reservation arena. Thus, like Air Broker Net.com they lack the ability to offer an automated commission sharing method between brokers and also show a limited resource base of aircraft in inventory.

As mentioned before, there are consolidating companies that have attempted to organize operator inventories and consolidate brokers. Doing so increases the resources available to the company but again, it still limits them to the few operators that are consolidated on their system. Huntington Travel.net is one such example. The model here provides a competitive scene for brokers to reserve aircraft on an availability basis. The sharing of commissions between brokers in real time due to an exclusive relationship model which the GFC system involves is nonexistent. Furthermore, the site offers a login capability for multiple brokers and travel agencies to login and choose from the operator's they are promoting. This identifies Huntington Travel.net as a service provider to the operator but not on an exclusive basis. The operators' goal to fill their planes to capacity can be open to other broker agencies too. With other brokers selling reservations on the same aircraft—Huntington Travel.net is not able to receive any commissions from the competitors efforts in real time.

Next, Netjets.com provides the same framework of reservation methods as Air Broker.com and Aviation-Broker.com. Here Netjets.com partly takes on an operator role in which they own and operate their own aircraft too. Essentially, Netjests.com is in a dual role as an operator and brokerage agency promoting their own aircraft. Being operators, promoting the aircraft to other brokers is possible and likely. So cooperation with other brokers can exist if so desired and remunerated according to internal negotiations between the parties. This is done on a case by case basis. This still does not equate to the broker to broker commission sharing model as depicted in the GFC system which also highlights continual revenue sharing abilities between broker parties each time reservations are generated for specific aircraft which any broker can register on the GFC Network. Once a broker registers an aircraft to the GFC Network, the system creates an exclusive relationship to that broker in that any operator wishing to cooperate in the reservation of that registered aircraft will be entitled to a proportional share of the reservation commissions on an on gong basis. This simply is nonexistent in the current system. The Netjets.com system does not allow for an exclusive relationship with a competitive broker to continually earn reservation revenues.

Finally, Avinode.com is an internet based site that features consolidation of flight schedules of various operators on an international scale in real time. Here, users of the system pay a subscription fee to access the systems key resources. Avinode.com provides a marketplace for brokers and operators to engage in flight reservations. The model here provides a competitive scene for brokers and operators to reserve and market aircraft on an availability and price basis. Key embodiments of the GFC invention like the model of sharing commissions between brokers in real time due to an exclusive relationship which the GFC system involves is simply non-existent here. Furthermore, the Avinode system does not model continual revenue sharing abilities between broker parties each time reservations are generated for specific aircraft which any broker can register on the GFC Network. In the GFC system, once a broker or operator registers an aircraft to the GFC Network, the GFC system creates an exclusive relationship to that registering, recruiting or sponsoring party in that any party wishing to cooperate in the reservation of that registered aircraft will be entitled to a proportional share of the reservation commissions on an on gong basis.

Accordingly, many websites are available for customers, brokers and operators to reserve aircraft. None are truly able to provide a virtual environment for accessibility to connected flight schedules in real time which allows for the creation of new systems that can use the connection data to improve and enhance reservation methods presently used within the commercial and private aviation industry today. It would be advantageous to provide the GFC system which also streamlines the laborious task of researching flight availabilities and prices in real time while creating a cooperative yet competitive environment so agencies and customers can all benefit on a continued recurring basis.

### SUMMARY OF THE INVENTION

The aim of this invention is to design an improved reservation system and method of its use conducted over the Internet through use of custom created (hardware and software) system which consolidates connected aircraft flight schedules in real time wherein an interactive environment with the system of users can create exclusive revenue relationships with any user of the Global Flight Center (GFC) system which includes all competitor brokers and operators registered over a distributed computer network.

The improved reservation system and method according to a preferred embodiment involves the connection of aircraft flight schedules to upload or registered to the GFC Network using the GFC website, i.e. database and managing resources, through which users of the system can access all inventory and other logistical flight data in real time thereby realizing a more efficient, resourceful and convenient source of information which creates improved reservation commissions. In addition, besides the new source of information gathered virtually through connected flight schedules, a preferred embodiment envisions and creates a new model of allowing any broker to exclusively register operators and other brokers to their brokerages such that, in the event any user of the system chooses to reserve aircraft which is already registered to a sponsoring broker, the sponsoring broker will be entitled to ongoing proportional revenues for that reservation. A broader preferred embodiment also creates and envisions this improved reservation system and exclusivity/revenue sharing model to function no differently in the air cargo transportation sector. Here the concept of reserving aircraft would not be for passengers but rather for air cargo transportation.

A preferred embodiment of the present invention entails customers, brokers and operators logging onto a Website where they can all participate in reserving aircraft to meet consumer demand. Once logged onto the network, users explore flights options available online and in real time through use of the data gathered from the connected flight schedules registered to the company network. The connected flight schedule are provided by operators who download their flight schedules through their existing flight management systems which then interfaces and uploads the logistical data to the GFC Network using custom software to facilitate the transfer. Operators who do not use flight management software in their business can also use the custom software to upload and transfer the data to the GFC system. In doing so, the GFC system becomes a resource center for real time aircraft availability. A preferred embodiment of the present invention further entails the system resource be used as a medium for any broker agencies to actively sponsor operators to the GFC Network in which the system models and manages an exclusive revenue bond between these registering or sponsoring brokers to the operators they recruit. Additionally, the exclusivity model further motivates broker agencies to sponsor/register competitor or fellow brokers to the GFC Network whereby allowing the system to create and manage an exclusive revenue bond relationship between the broker and the sponsored brokers they recruit and their proportional reservation income the system allows them to share. Furthermore, this exclusive relationship and revenue bond invention within the system is not limited to just Brokers and Operators, but rather allows for any User to recruit any other User to the GFC Network.

Unlike current marketing methods where brokers and operators independently compete for reservation revenues, another preferred embodiment of the invention envisions the GFC model as an unparalleled opportunity for brokers and operators to united and consolidates an industry of disconnected aircraft itineraries thereby creating an efficient and effective resource for all users of the system while remaining competitive. A prerequisite is that users have Internet access and operators are willing to provide their reservation and flight logistics to the company Network. The Internet access can be gained at various locations, which include but are not limited to, home and work and other capable facilities. The logistical data can be uploaded through use of software which the system will share with operator and also through a personal contact with the company support department if needed.

### BRIEF DESCRIPTION OF THE DRAWINGS

The features and embodiments of the present invention are presented in the following drawings and flow charts which are numbered illustrating key elements and modules of the GFC system:

FIG. 1A, 1B, 1C, 1D represent exemplary diagram showing the Legend for symbols used for all featured diagrams used in the GFC system in accordance with embodiments of the invention;

FIG. 2 shows an exemplary flow diagram showing the Current/Classical Consolidation principal or connection method of a customer connected to an aircraft Operator;

FIG. 3 shows an exemplary flow diagram showing the Internet connection and Data Exchange connectivity of the aircraft Operator connected to the GFC system in accordance with one embodiment of the invention;

FIG. 4 shows an exemplary flow diagram showing the Internet connection and Data Exchange connectivity of the Brokers connected to the GFC system in accordance with one embodiment of the invention;

FIG. 5A shows an exemplary flow diagram showing the Internet connection and Data Exchange connectivity of the Users—GFC clients connected to the GFC system in accordance with one embodiment of the invention;

FIG. 5B shows an exemplary flow diagram showing the Internet connection and Data Exchange connectivity of the Users—GFC Airport accounts connected to the GFC system in accordance with one embodiment of the invention;

FIG. 5C shows an exemplary flow diagram showing the Internet connection and Data Exchange connectivity of the Users—GFC Handlers connected to the GFC system in accordance with one embodiment of the invention;

FIG. 5D shows an exemplary flow diagram showing the Internet connection and Data Exchange connectivity of the Users—GFC Warehouses connected to the GFC system in accordance with one embodiment of the invention;

FIG. 5E shows an exemplary flow diagram showing the Internet connection and Data Exchange connectivity of the Users—Custom Brokers connected to the GFC system in accordance with one embodiment of the invention;

FIG. 6 shows an exemplary flow diagram showing the GFC Consolidation model with Internet connection of connected GFC accounts interconnected to all parties in the system in accordance with one embodiment of the invention;

FIG. 7 shows an exemplary flow diagram showing the Enrollment process of a new GFC User to the GFC system connecting to an aircraft Operator in accordance with one embodiment of the invention;

FIG. 8 shows an exemplary flow diagram showing the Exclusivity relationship between GFC Broker and Aircraft Operator connected to the GFC system in accordance with one embodiment of the invention;

FIG. 9 shows an exemplary flow diagram showing the Exclusivity relationship between GFC Broker and a GFC Sub Broker (Sponsored/Recruited Broker) connected to the GFC system in accordance with one embodiment of the invention;

FIG. 10 shows an exemplary flow diagram showing the Exclusivity relationship between GFC Broker and Registered GFC User (registered to GFC system) connected to the GFC system in accordance with one embodiment of the invention;

FIG. 11 shows an exemplary flow diagram showing the GFC Revenue Share principle between Brokers depicting and Exclusivity between Broker and Aircraft Operator connected to the GFC system in accordance with one embodiment of the invention;

FIG. 12 shows an exemplary flow diagram showing the GFC Revenue Share principle between Brokers depicting and Exclusivity between Broker and User connected to the GFC system in accordance with one embodiment of the invention;

FIG. 13 shows an exemplary flow diagram showing the GFC Revenue Share principle between Brokers depicting and Exclusivity between Broker and a Sub Broker (sponsored/recruited Broker) connected to the GFC system in accordance with one embodiment of the invention;

FIG. 14 shows an exemplary flow diagram showing the data exchange connections of Airports, aircraft Handlers, cargo Handlers, warehouse Operators and Customs brokers connected to the GFC system in accordance with one broader embodiment of the invention;

FIG. 15 shows an exemplary flow diagram showing the application of the GFC inventions as it applies to the Air Cargo industry;

FIG. 16 shows an exemplary diagram showing the GFC payment system and commission share (option 1) applied for the Air Cargo industry;

FIG. 17 shows an exemplary diagram showing the GFC payment system and commission share (option 2) applied for the Air Cargo industry; and

FIG. 18 shows an exemplary diagram showing the GFC payment system and commission share (option 3) applied for the Air Cargo industry.

### DESCRIPTION OF THE PREFERRED EMBODIMENTS

The aim of this invention is to design an improved reservation system and method of its use conducted over the Internet through use of custom created (hardware and software) system which consolidates connected aircraft flight schedules in real time wherein an interactive environment with the system of users can create exclusive revenue relationships with any user of the Global Flight Center (GFC) system which includes all competitor brokers and operators registered over a distributed computer network.

This invention involves reservation broker agencies and operators participating in an improved marketing method in the interactive environment. The parties primarily communicate through the Internet which accesses connected aircraft flight schedule data uploaded by operators registered to the GFC system. In accordance with a preferred embodiment, a registration process takes place by users entering their personal and hardware data through the GFC website. Custom created software and hardware are used to assist the users in this process. The logistical flight data is used as a foundation for creating the improved marketing method which allows the use of an exclusive relationship connection method between broker, operator and users of the system which is exclusive to the invention. It further allows for the creation of an exclusive revenue bond structure with is also exclusive to the invention and allows for brokers and sponsored brokers to proportional share reservation commission with each other while maintaining a competitive environment.

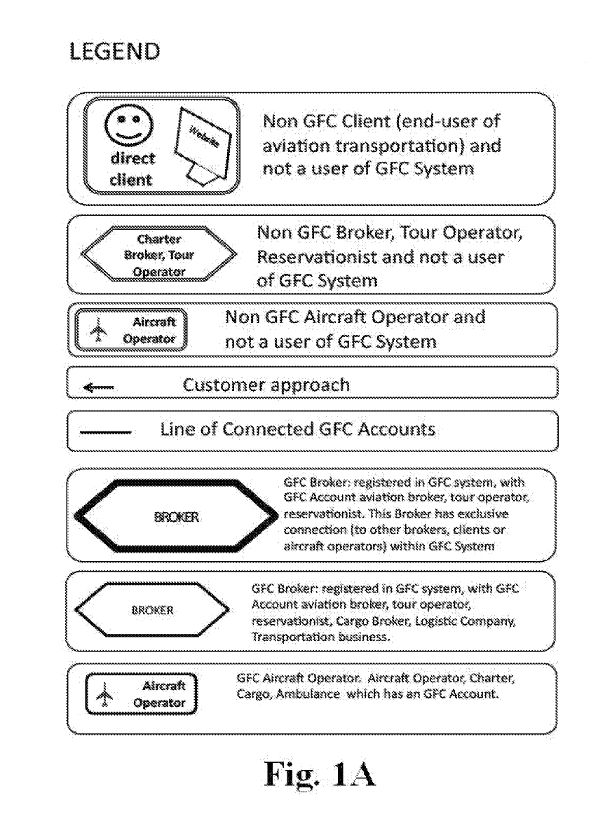

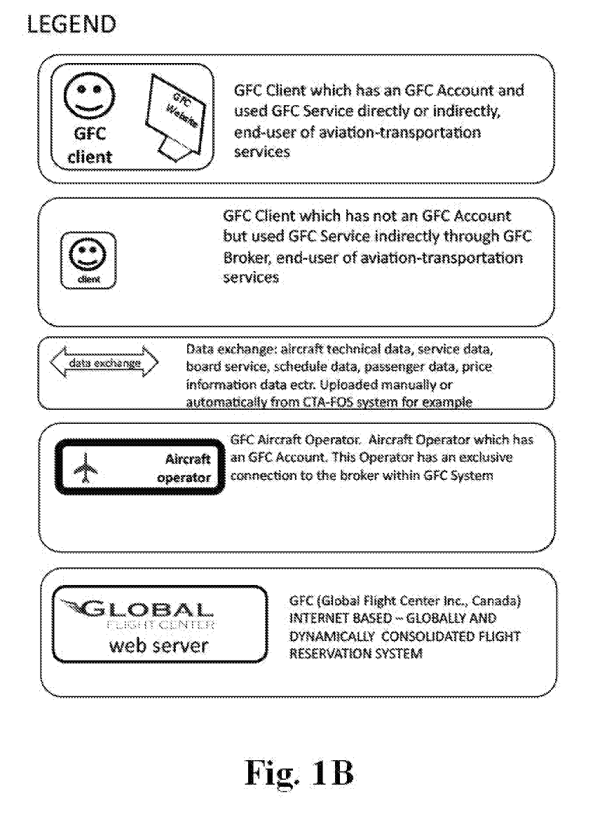

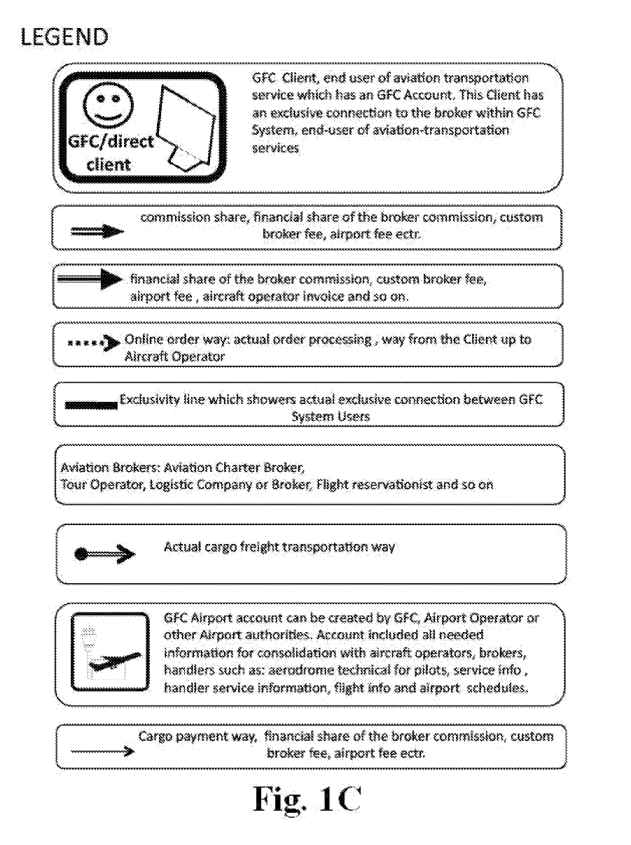

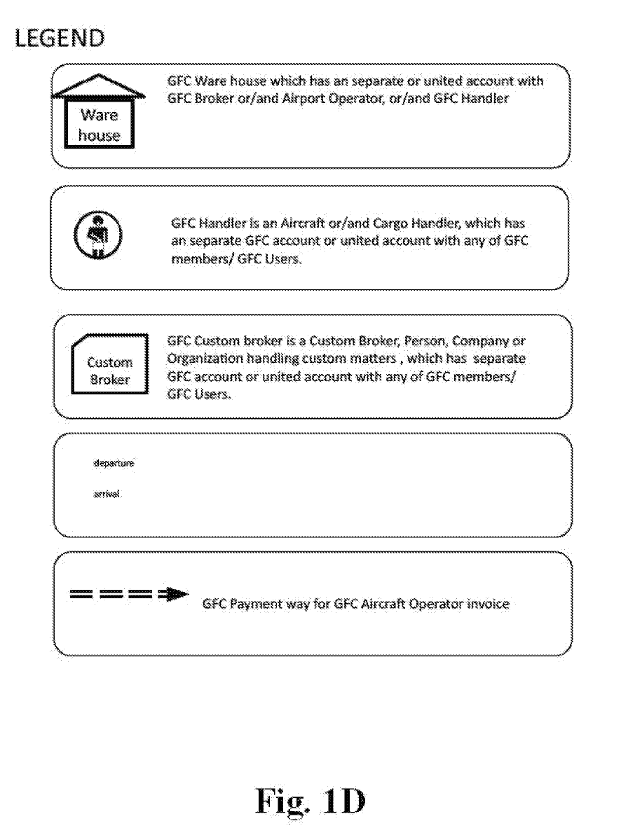

FIG. 1 (FIG. 1A, 1B, 1C, 1D) comprises of 4 figures and is an exemplary diagram showing the Legend for symbols used for all featured diagrams used in the GFC system in accordance with embodiments of the invention.

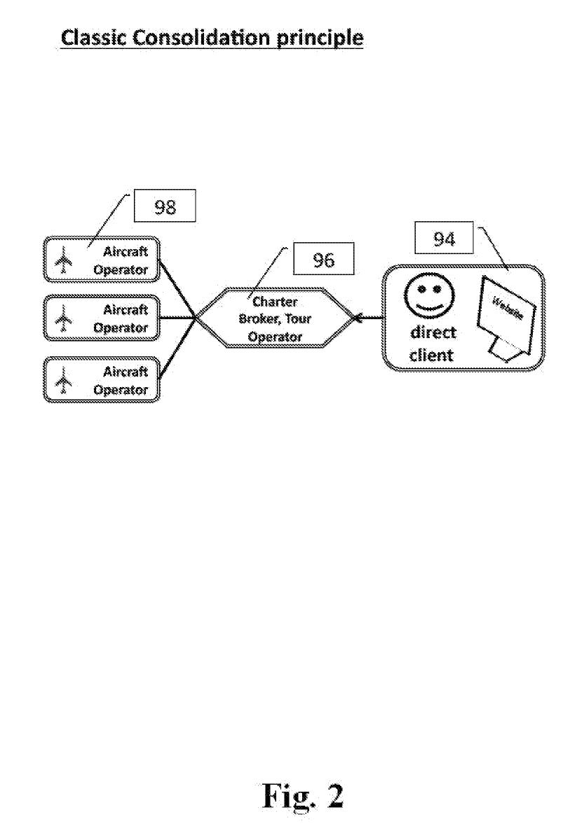

FIG. 2 is an exemplary flow diagram showing the Current/Classical Consolidation principal or connection method of a customer connecting to an aircraft Operator. This diagram consists of following several modules: direct client (94), charter broker/tour operator (96) and the net of aircraft operators (98). Using direct client module (94) a solicited customer logs onto the interactive environment (website) to Brokers agency (96) to book a reservation. The Broker agency (96) is affiliated with multiple aircraft Operators (98). The figure shows a direct connection between broker (96) and operator (98) to facilitate the customers (94) demand. It also shows the broker (96) to have a consolidated type relationship with multiple operators (98) to facilitate incoming consumer demand. This diagram represents the existing landscape of Internet based reservation logistics today.

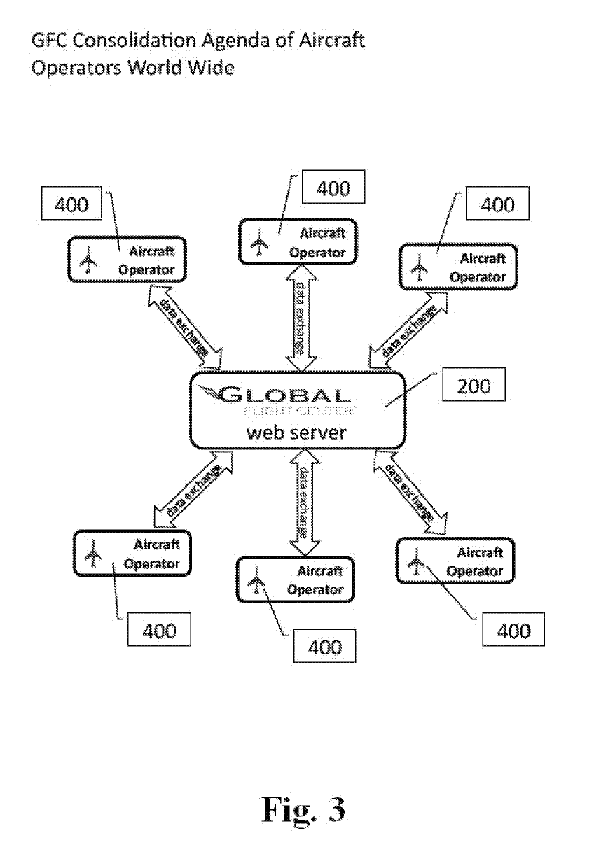

FIG. 3. is an exemplary flow diagram showing the Internet connection and Data Exchange connectivity of the aircraft Operator (400) connected to the GFC system (200) in accordance with one embodiment of the invention. GFC system/ GFC Webserver (200) is shown as a source for the storage of consolidated flight data and in general a data warehouse of consolidated data from globally registered aircraft Operator (400) to the GFC (200). The data exchange is a 2 way communication stream between Operator (400) and GFC (200) driven through the Internet by means of customized software and hardware which facilitates the process in real time.

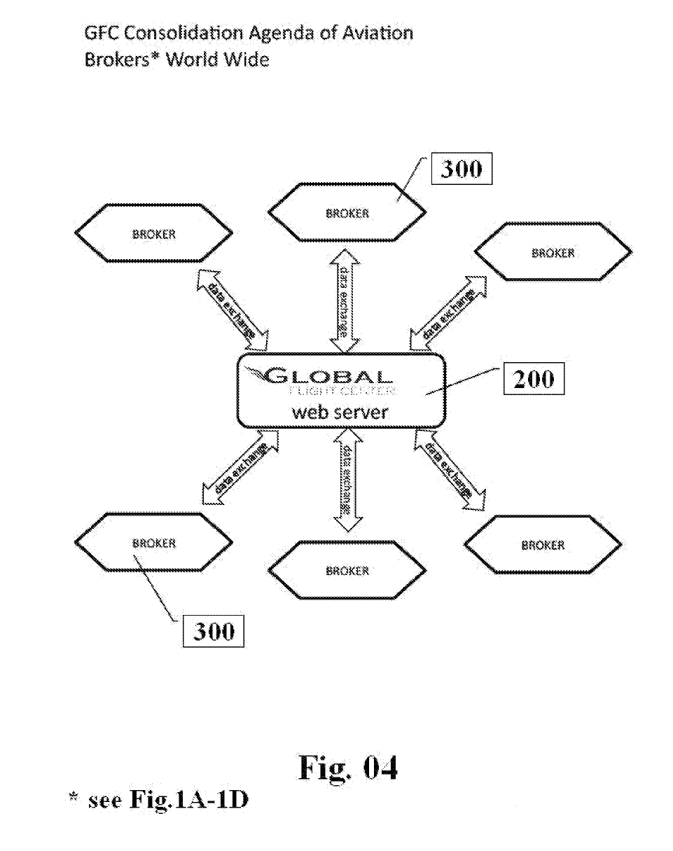

FIG. 4 is an exemplary flow diagram showing the Internet connection and Data Exchange connectivity of the Brokers (300) connected to the GFC system (200) in accordance with one embodiment of the invention. Here again, GFC system/GFC Webserver (200) is shown as a source for the storage of consolidated data and in general a data warehouse of consolidated data from globally registered Brokers (300) to the GFC system (200). The data exchange is a 2 way communication stream between Broker (300) and GFC (200) driven through the Internet by means of customized software and hardware which facilitates the process in real time.

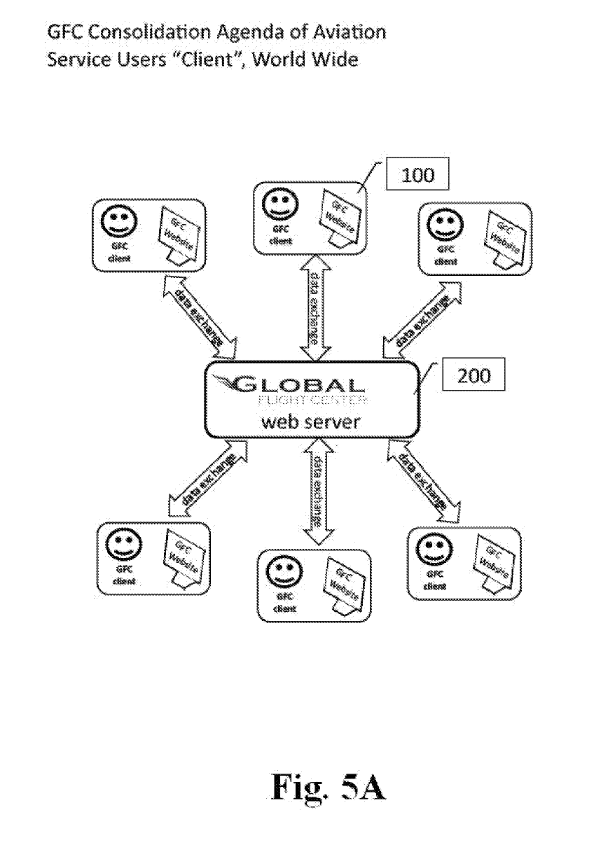

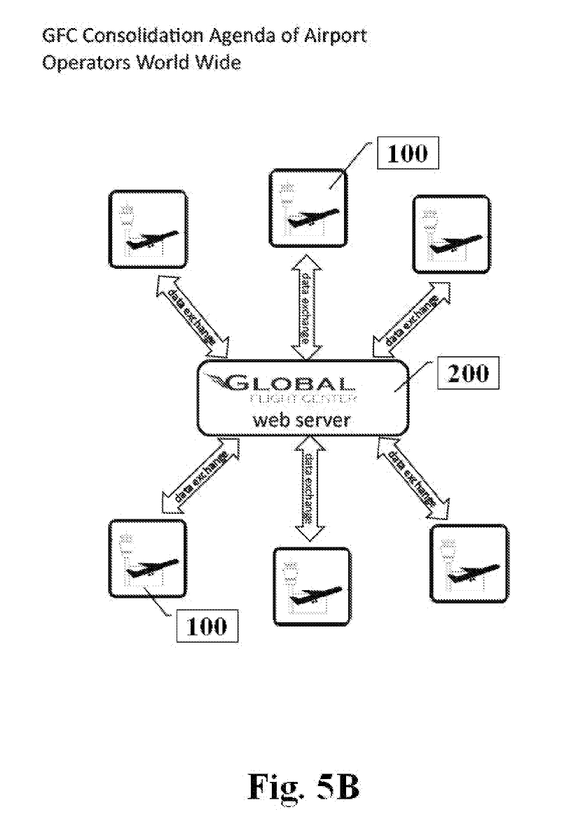

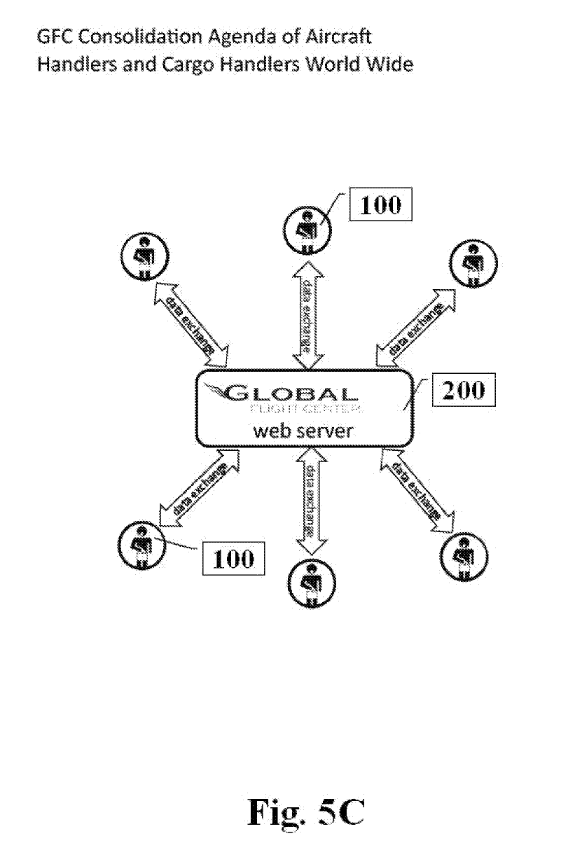

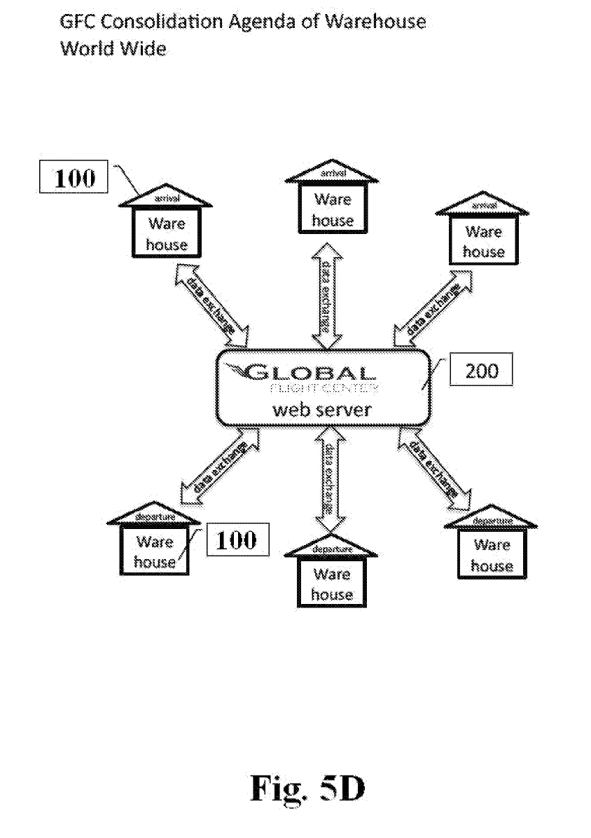

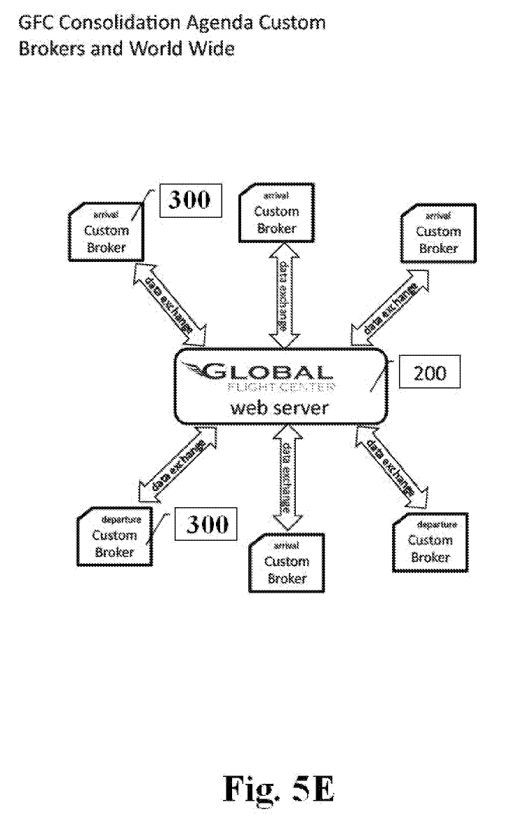

FIG. 5 (FIG. 5A, 5B, 5C, 5D, 5E) are an exemplary flow diagrams showing the Internet connection and Data Exchange connectivity of the Users (100, 300) connected to the GFC system (200) in accordance with one embodiment of the invention. GFC system/GFC Webserver (200) is shown as a source for the storage of consolidated data and in general a data warehouse of consolidated data from globally registered Users (100, 300) to the GFC system (200). The data exchange is a 2 way communication stream between Users (100, 300) and GFC system (200) driven through the Internet by means of customized software and hardware which facilitates the process in real time.

Throughout FIGS. 3, 4 and 5, GFC system/GFC Webserver (200) is shown as a centralized source for the storage and manage of consolidated data and in general a data warehouse of consolidated data from globally registered Users: Brokers (300) and aircraft Operators (400) to the GFC system (200). By means of the Internet/interactive systems, the exchange of data is communicated between all parties by means of customized GFC software and hardware which facilitates the process dynamically in real time. This consolidation of data from all parties creates the foundation of the system in which preferred embodiments can be seen.

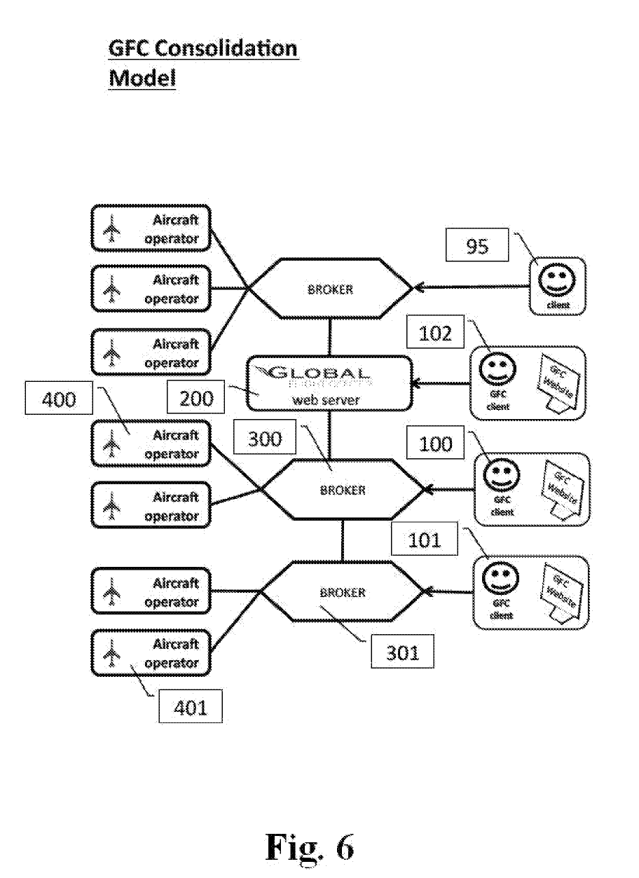

FIG. 6 is an exemplary flow diagram showing the GFC Consolidation model (module) with interactive environment (Internet connection) of connected GFC accounts as depicted in the preceding FIGS. 3, 4 and 5, and also other non-registered users all interconnected to all parties in the system in accordance with one embodiment of the invention. A further explanation of the model highlights a customer approach to reserving an aircraft as illustrated in item (100) in which a GFC registered user as indicated by definitions in the Legend, reserves an registered aircraft which is consolidated within the GFC system with Broker (300). It further illustrates a registered user reserving an aircraft through a Sub broker relationship as depicted in item (101, 301, 401). Another consolidated method as described by item (102) depicts a customer directly approaching GFC to reserve an aircraft which ultimately gets directed and reserved through a GFC Broker to complete the transaction. Item (95) shows a non-registered user of the GFC system simply reserving an aircraft through the GFC Broker. In this way FIG. 6 demonstrates not only the interaction of described objects between themselves but also it is very obviously seen how the present invention integrates to itself the classic consolidation system described in FIG. 2.

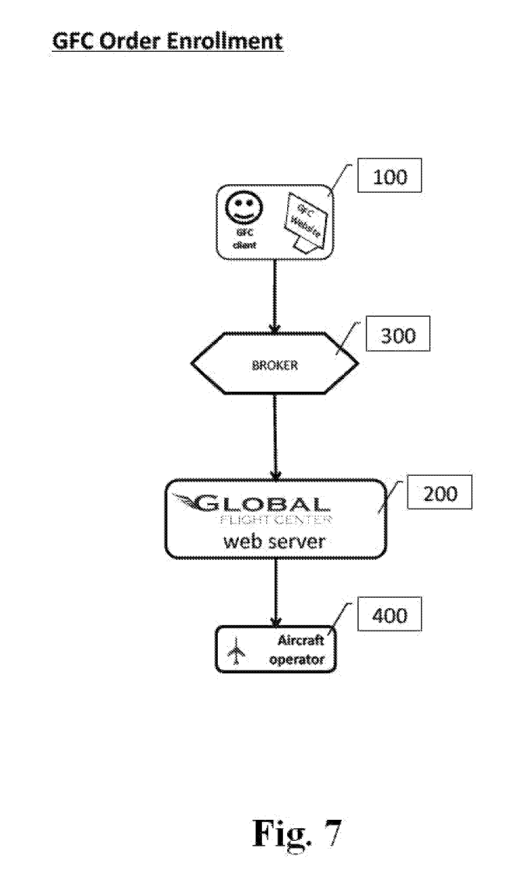

FIG. 7 is an exemplary flow diagram showing the Enrollment process of a new GFC User (100) to the GFC system (200) connecting to an aircraft Operator (400) in accordance with one embodiment of the invention. Here, in item (100), a solicited customer by means of advertising, email, direct mail advertisements, or simply a new Website visitor, registers to the GFC system (200) in effort to reserving an aircraft. The important order method depicted here shows a mandatory connection of the GFC User (100) to a Broker (300) which is connected to the GFC system (200) and in which the logistical data for flight reservation is connected only through the GFC system (200) to the registered aircraft Operator (400). In a non GFC model, a customer need not go through a broker. Aircraft Operators market their availabilities through similar methods of advertising, email, direct mail advertisements, or simply a new Website visitor as well. The customer need not go through a broker either. A customer going through the GFC website and wishing to book an aircraft will be redirected to a broker who would then complete the transaction.

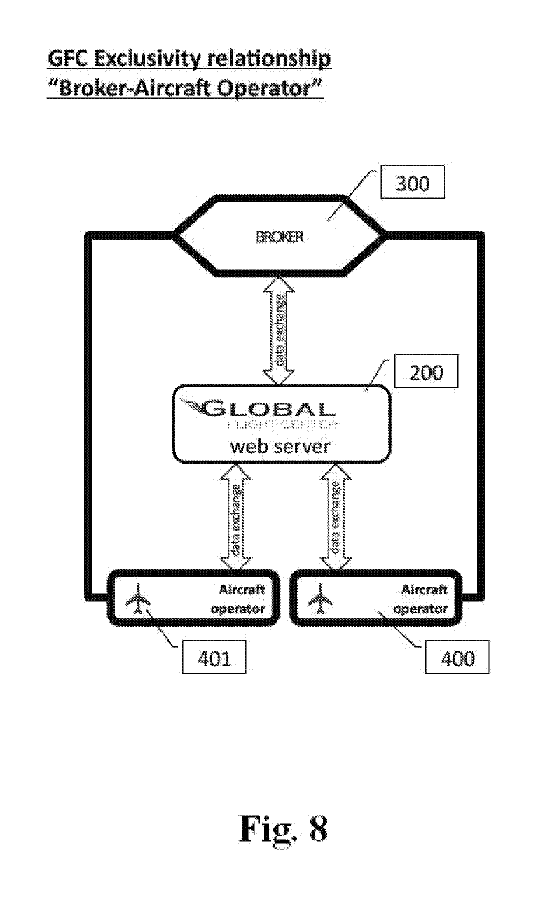

FIG. 8 is an exemplary flow diagram showing the Exclusivity relationship between GFC Broker (300) and Aircraft Operator (400, 4101) connected to the GFC system (200) in accordance with one embodiment of the invention. The Broker (300) depicted here shows as a registered GFC broker (300) by description in the legend. A registered Broker (300) can be an individual, tour operator, agency or simply any party who may have recruited/sponsored the aircraft Operator (400) to the GFC system (200). The diagram highlights one aspect of the invention as it describes a Broker (300) with an exclusive relationship with 2 different aircraft Operators (400, 401). The Broker (300) is not limited to only 2 exclusive relationships. Broker (300) can have as many exclusive relationships as the Broker (300) may choose to sponsor to the GFC system (200). The diagram shows the Operators (400, 401) registered to the GFC system (200), through a recruitment process by the Broker (300). Any User or customer wishing to reserve either aircraft from aircraft Operators (400, 401) using the GFC system (200) website, will be involved with Broker (300) in which Broker (300) will always be either directly or indirectly involved with a proportional commission in the reservation. The diagram depicts an exclusive Broker (300) to Aircraft Operator (400) relationship within the GFC system (200).

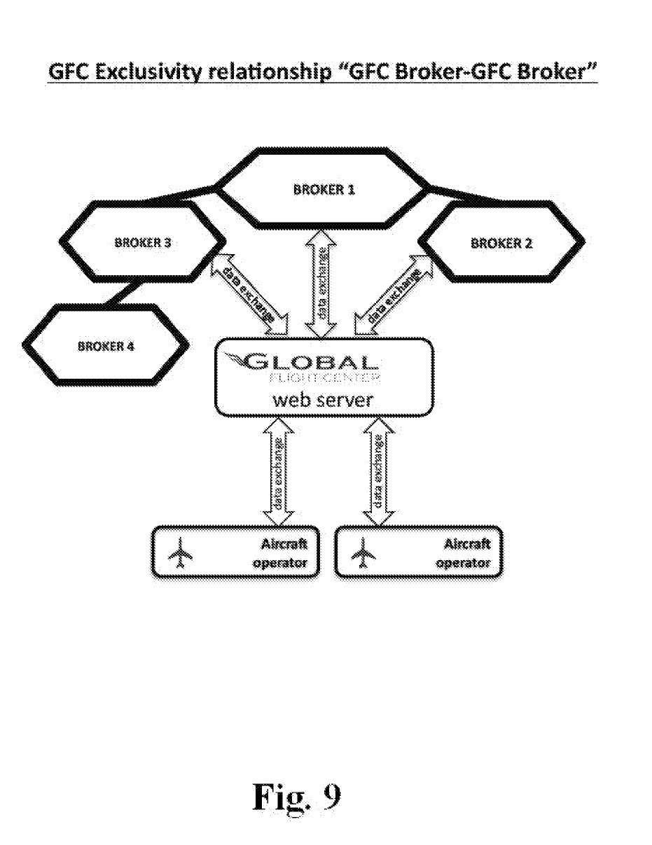

FIG. 9 is an exemplary flow diagram showing the Exclusivity relationship between GFC Broker (and a GFC Sub Broker (sponsored/recruited Broker) connected to the GFC system in accordance with one embodiment of the invention. This diagram highlights the invention of the exclusivity relationship between 4 different brokers as labeled. Here broker 1 is the sponsor broker who recruited Broker 2 and Broker 3. The diagram depicts Brokers 2 and 3 as Sub Brokers to Broker 1. Any reservations commissions generated from broker 2 or 3 within this model will proportionately pay Broker 1 ongoing commissions as allowed and governed within the GFC system. This model also infers a competitive need for Brokers 2 and 3 to recruit and sponsor their own Broker relations as to generate a passive revenue bond like Broker 1 realizes with Broker 2 and 3's efforts. The GFC model only depicts and allows for the recruitment of 1 level of Sub Brokers. Broker 1 can have and is encouraged to recruit as many Brokers and Operators as he can but would not be able to benefit from the recruitments of his Sub Brokers. This is not a Multi-level marketing method that goes deeper than 1 level of benefits to the Sponsoring party. For example, should Broker 3 be able to recruit a Broker 4 within the GFC system. Broker 1 would not be eligible for a proportional commission on the efforts of Broker 4. Only Broker 3 would have that ongoing privilege.

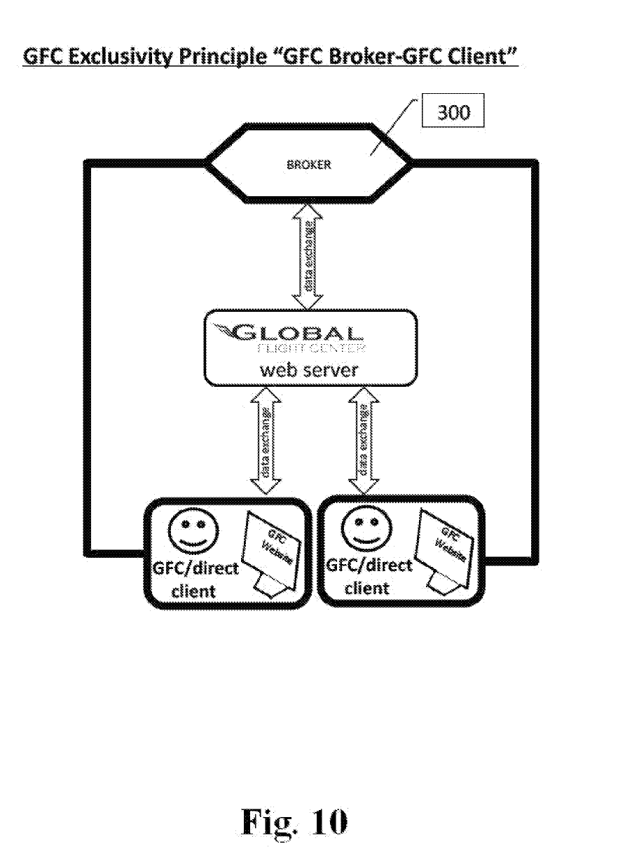

FIG. 10 is an exemplary flow diagram showing the Exclusivity relationship between GFC Broker (300) and Registered GFC User (100) (registered to GFC system) connected to the GFC system (200) in accordance with one embodiment of the invention. This diagram depicts the exclusivity model invention between brokers and customers who register within the GFC system (200). In a traditional model as described in FIG. 2, a customer would be free to choose any aircraft (400) or broker (300) agency as desired. This freedom is allowed with the GFC system (200) too, however due the inventions of an exclusivity relationship between parties and a revenue bond sharing marketing model, if a Broker (300) sponsors a customer to the GFC system (200) and the GFC user chooses to reserve an aircraft through other GFC broker solicitations, then Broker (300) would be eligible for a proportional passive commission which would be shared from the other broker who solicited the reservation. This highlights the exclusivity principle within the invention.

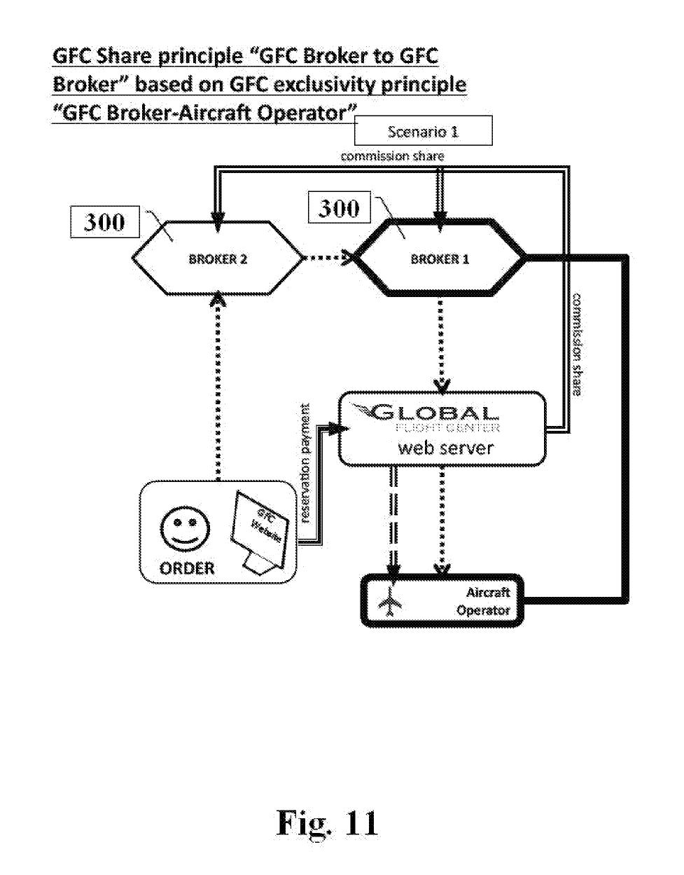

FIG. 11 is an exemplary flow diagram showing the realization of the GFC Revenue Share principle between Brokers (300) depicting and Exclusivity between Broker (300) and Aircraft Operator (400) connected to the GFC system (200) in accordance with one embodiment of the invention. The illustration depicts a scenario in which a reservation order from a competitor broker (300) plays out in the GFC system (200). FIG. 8 has referenced the exclusivity relationship between Broker (300) and Aircraft Operator (400) within the GFC system (200). The exclusive relation between Broker 1 (300) to Aircraft Operator (400) enables Broker 1 (300) to ongoing revenue streams to the sponsored aircraft operator. Here Broker 2 (300), a competitor broker within the system has an order request in which both Brokers (300) earn proportional revenues due to exclusivity relationship invention with Broker 1 (300) to the aircraft Operator (400).

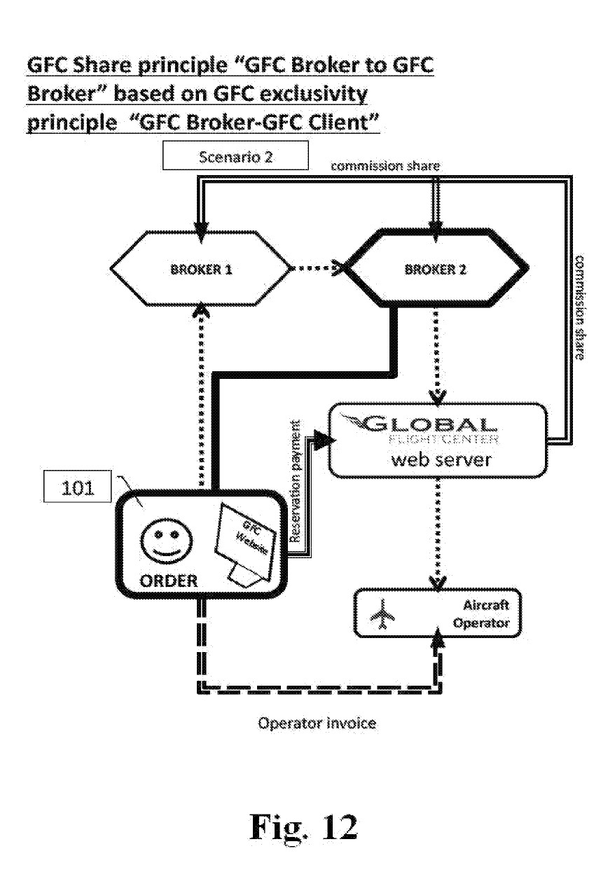

FIG. 12 is an exemplary flow diagram showing the GFC Revenue Share principle between Brokers (300) depicting and Exclusivity between Broker (300) and User (100) connected to the GFC system (200) in accordance with one embodiment of the invention. Here, an exclusive relationship exists as described in FIG. 10, between Broker 2 (300) and the ordering customer (101). The scenario depicts an order solicited by a competitor broker shown as Broker 1 (300) in which Broker 2 (300) due to its exclusive relationship with the ordering customer (101) within the system will earn a proportional passive income on the fulfillment of this reservation. As a general note, the proportional amounts between the parties are governed within the system and may change from time to time.

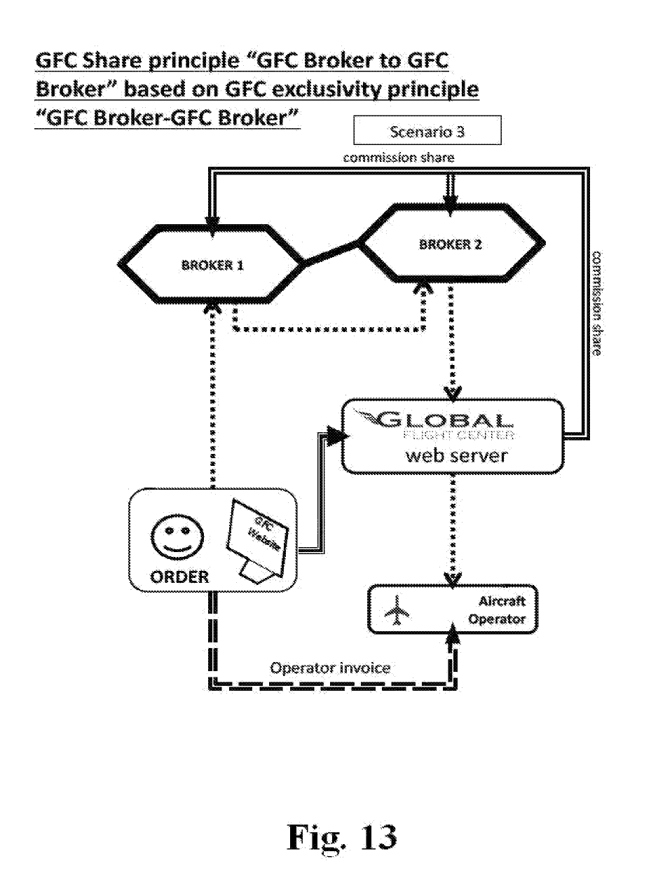

FIG. 13 is an exemplary flow diagram showing the GFC Revenue Share principle between Brokers (300) depicting and Exclusivity between Broker (300) and a Sub Broker (sponsored/recruited Broker) connected to the GFC system (200) in accordance with one embodiment of the invention. Here, Broker 2 (300) is shown as the sponsoring broker and has recruited Broker 1 (300) to the GFC system (200). A reservation order, as illustrated within the Figure depicts a scenario in which Broker 2 (300), being the sponsoring broker will be eligible for ongoing commission for the efforts of Broker 1 (300) which in this scenario is shown as the soliciting broker for the reservation order. The proportional commissions between the parties would again be governed by parameters set within the GFC system (200).

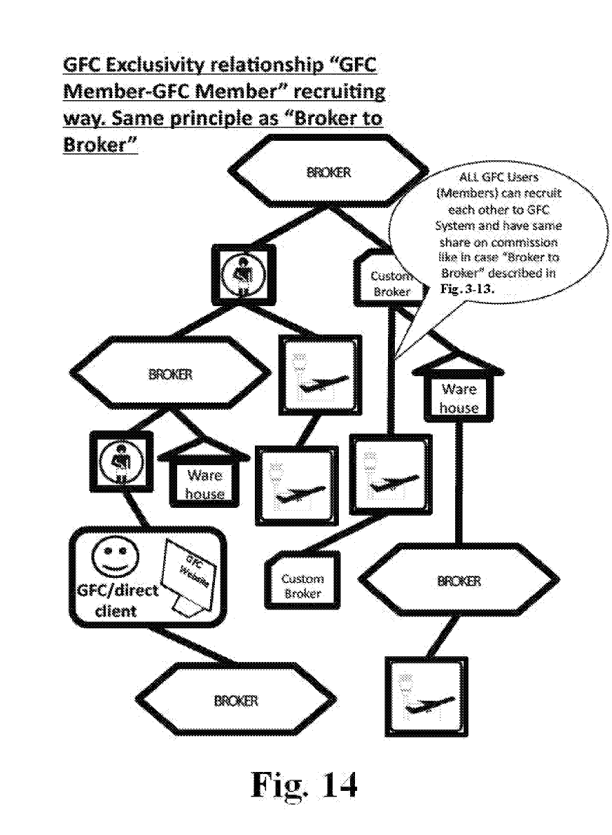

FIG. 14 is an exemplary flow diagram showing the data exchange connections of Airports, aircraft Handlers, cargo Handlers, warehouse Operators and Customs brokers connected to the GFC system (200) in accordance with one broader embodiment of the invention. Here the data exchange is a 2 way communication stream between the above mentioned parties and GFC system, which is driven through the Internet by means of customized software and hardware which facilitates the process in real time. Each party represented in FIG. 3-13 can be considered as a sponsoring parties in the Cargo Transportation industry. The exclusivity principal and relationships as in the prior passenger models is also applicable to the Cargo transportation industry. Exclusive and proportional revenue sharing principles can exist within the Cargo transportation industry as created in the Passenger transportation industry.

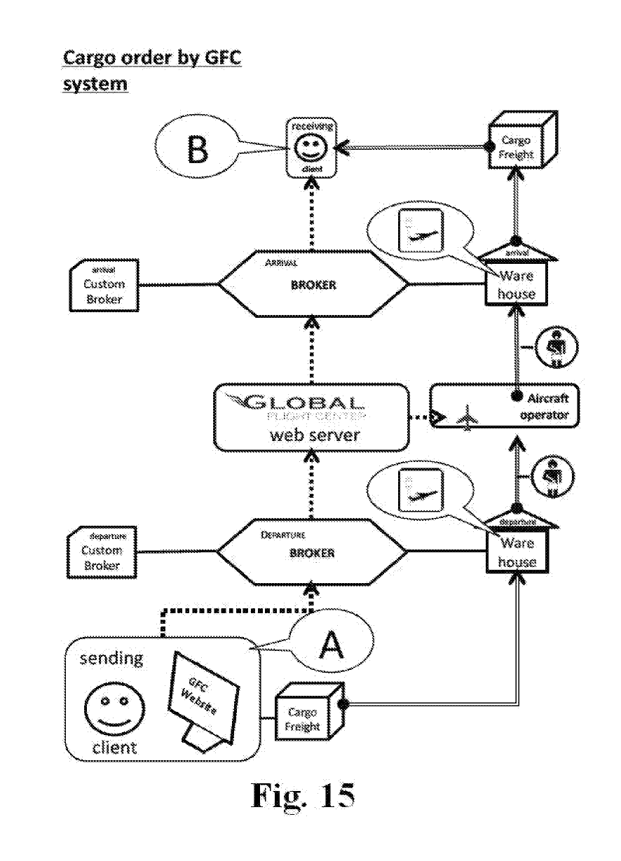

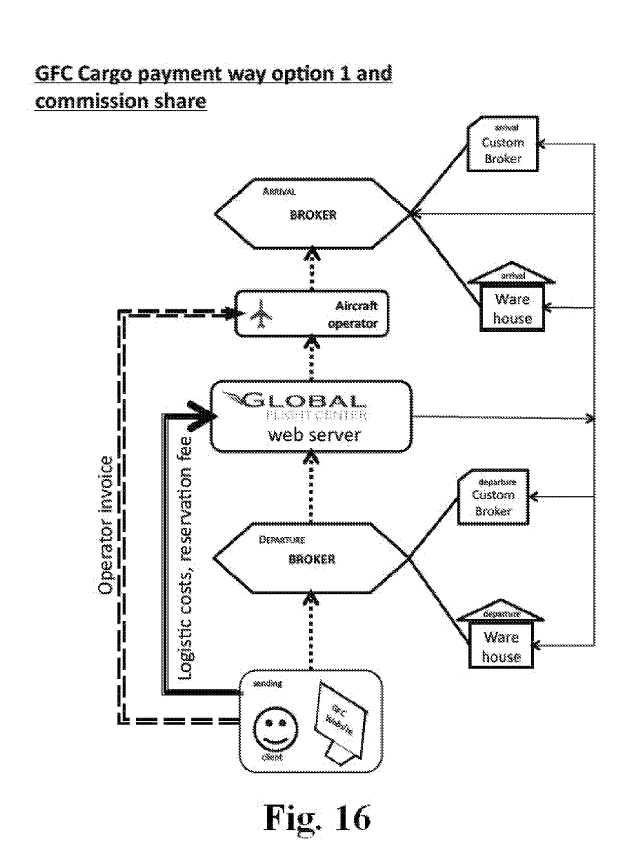

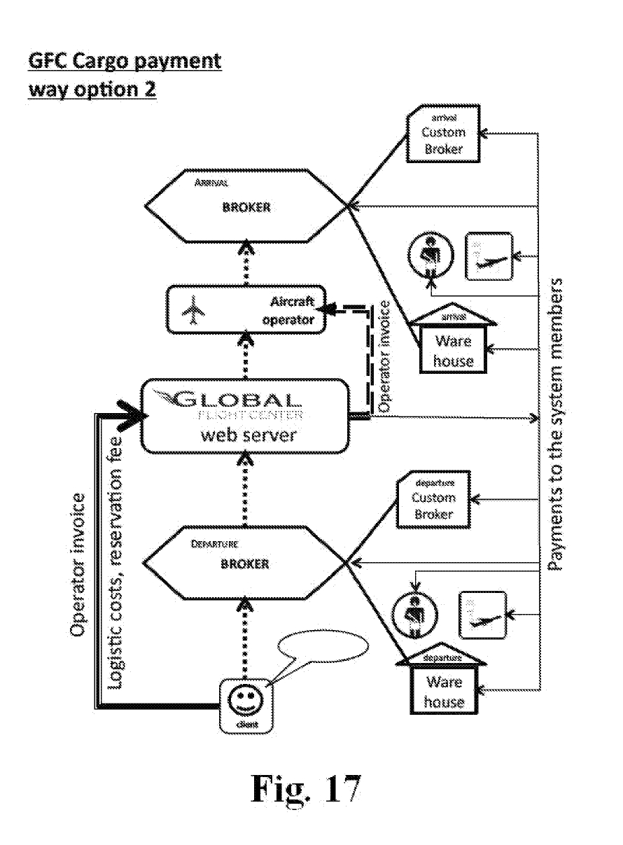

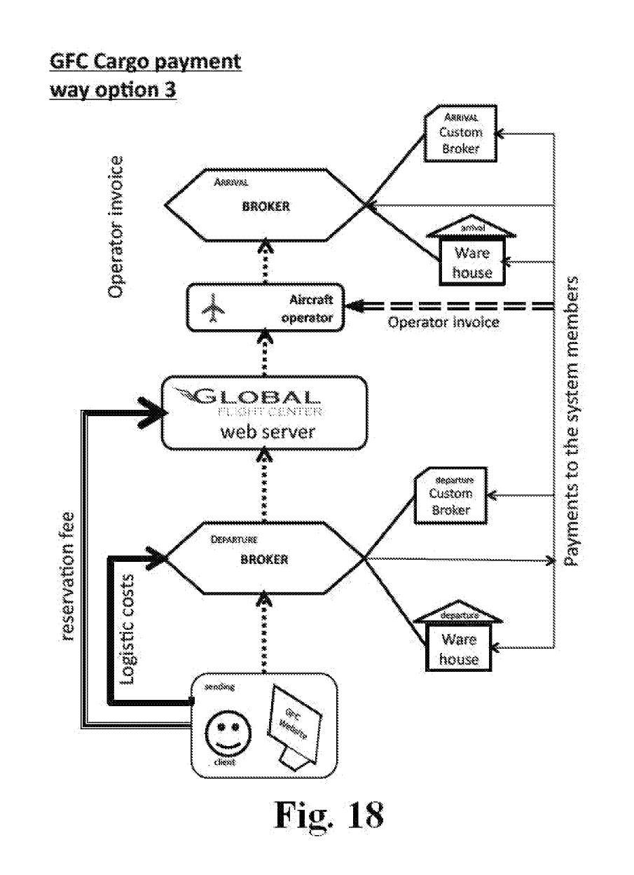

FIG. 15 is an exemplary flow diagram showing the application of the GFC inventions as it applies to the Air Cargo industry. Here, a cargo package is shown moving from item A to B with the introduction of other GFC parties such as Custom brokers, Warehouses, Cargo handlers and Airport authorities which do not exist in the passenger model. Exclusivity relationships can exist between these parties and subsequently proportional revenues between them as depicted in FIGS. 16, 17 and 18, which are governed within parameters, set in the GFC system (200).

The invention has been illustrated and described with reference to general and preferred embodiments thereof, it will be understood by those skilled in the related field that various changes in form, details and scenarios may be made therein without departing from the spirit and scope of the invention. This is not a comprehensive or restrictive invention aiming for identifying an exact form or way of implementation. The previously presented description has to be seen as an illustration and not as a restriction. It is obvious that many modifications and variations can be obvious for the specialists of this field. Ways of implementation are chosen and described so that the specialists of the field could better explain the principles of the invention and the best practical application for different implementation ways with different modifications, suitable for a certain usage or application.

1. An improved reservation system for passenger and cargo aircrafts among service suppliers and service buyers, the improved reservation system comprising:
a global flight center (GFC) system, connected with different level clients, brokers and aircraft operators, wherein the global flight center system:
comprises databases, software and hardware resources realized as interactive website or computer network, through which users of the system can access all the inventory, resources and logistical data in real time on a global scale;
is configured to operate over the Internet by giving system users the ability to reserve aircraft resources in real time globally;
is configured to connect aircraft operators' databases/resources and manage/update them in real time globally;
is configured to connect brokers and different level clients and enable them to see (visualize) and manage in real time flight schedules and availabilities of all aircrafts (commercial or chartered) that are registered to this (GFC) system;
is configured to create an improved marketing method and possibilities between broker agencies and air craft owner operators;
is configured to create a special motivating system and encouragement factor for brokers and agencies to register as many relationships with aircraft operators as they can in so they can increase their income potential through a dynamic internet based selection process in real time through use of the mentioned GFC system;
is configured to create a dynamic commissions sharing relationship structure (module) between competitive brokers and agent parties who presently reserve the aircraft; and
is configured to create a unique exclusive relationship concept and a special broker to broker commission concept in the aviation transportation field;
wherein the consolidation of connected operator flight schedules through the GFC Network—travel agents, brokers and reservationists have not only found a new resource, but also a new opportunity for generating new income streams; and
wherein the GFC system and its use highlights an exclusive relationship model between brokers and aircraft operators and a special broker to broker commission model both creating an improvement in current methods in which all parties can increase their reservations commissions.
